(19) United States
(12) Patent Application Publication
(10) Pub. No.: US 2025/0013545 A1
(43) Pub. Date: Jan. 9, 2025

(54) ANOMALY DETECTION PROCESSING METHOD AND DEVICE FOR SOLID-STATE DRIVE

(71) Applicant: Samsung Electronics Co., Ltd., Suwon-si (KR)

(72) Inventors: Ni XUE, Xi'an (CN); Yeyang WANG, Xi'an (CN); Zhixue ZHAO, Xi'an (CN); Jiaming WANG, Xi'an (CN)

(73) Assignee: Samsung Electronics Co., Ltd., Suwon-si (KR)

(21) Appl. No.: 18/675,483

(22) Filed: May 28, 2024

(30) Foreign Application Priority Data
Jul. 4, 2023 (CN) 202310811163.7

(51) Int. Cl. G06F 11/22; G06F 11/277

(52) U.S. Cl. CPC G06F 11/2268; G06F 11/2257; G06F 11/277

(57) ABSTRACT

An anomaly detection processing method and device for solid-state drive (SSD) are provided. The anomaly detection processing method for SSD including collecting test data of an SSD, the test data including at least one of self-monitoring, analysis and reporting technology S.M.A.R.T. data, NAND flash cell threshold voltage distribution data, and bit error rate eye diagram data, determining whether the SSD has an anomaly based on the test data, and determining an anomaly cause of the SSD based on a subset of test data, the subset including specific test data based on which the SSD has been determined to have an anomaly may be provided.

### CROSS-REFERENCE TO RELATED APPLICATIONS

This application claims priority under 35 U.S.C. § 119 to Chinese Patent Application No. 202310811163.7, filed on Jul. 4, 2023, in the State Intellectual Property Office of the P.R.C., the disclosure of which is incorporated herein in its entirety by reference.

### BACKGROUND

### Technical Field

The present disclosure relates to a storage field, and in particular to anomaly detection processing methods and/or devices for solid-state drive.

### Description of the Related Art

Self-monitoring, analysis, and reporting technology (S.M.A.R.T.) is a monitoring system for a storage drive (such as solid-state drive (SSD) and hard disk drive (HDDs)), which can collect information about the execution and/or health condition of the storage drive and provide the collected information to a user. Since the attributes reported by S.M.A.R.T. are fixed and limited, many vendors have proposed the Extended S.M.A.R.T. to customize the execution and/or health condition information of the storage drive.

At present, there are many methods for anomaly detection or failure prediction for the SSD based on S.M.A.R.T. and extended S.M.A.R.T. However, these methods generally have drawbacks including limited amount of acquired information, relying on manual operations such as the tester viewing logs to determine reliability of the SSD while further leading to hysteresis in the results, lack of explanation for the anomaly causes of the SSD, and the deep-seated anomaly causes that are not explored.

### SUMMARY

According to an example embodiment of the present disclosure, an anomaly detection processing method for solid-state drive SSD may include collecting test data of an SSD, the test data including at least one of self-monitoring, analysis and reporting technology S.M.A.R.T. data, NAND flash cell threshold voltage distribution data, and bit error rate eye diagram data, determining whether the SSD has an anomaly based on the test data, and determining an anomaly cause of the SSD based on a subset of the test data, the subset including specific test data based on which the SSD has been determined to have the anomaly.

The determining whether the SSD has an anomaly may include determining whether the SSD has the anomaly, based on the S.M.A.R.T. data by using a trained first anomaly detection model, based on the NAND flash cell threshold voltage distribution data by using a second anomaly detection model, and based on the bit error rate eye diagram data by using a trained third anomaly detection model, or determining whether the SSD has the anomaly based on the S.M.A.R.T. data, the NAND flash cell threshold voltage distribution data, and the bit error rate eye diagram data, by using a trained anomaly detection model.

The determining an anomaly cause of the SSD may include determining, by using a trained anomaly cause analysis model, the anomaly cause of the SSD based on the subset of the test data.

Before the determining whether the SSD has an anomaly, feature extraction may be performed on the test data to obtain features of the test data.

For the S.M.A.R.T. data, the collecting test data of an SSD may include collecting a S.M.A.R.T. dataset of the SSD, the S.M.A.R.T. data set including S.M.A.R.T. data, determining a correlation between each S.M.A.R.T. data in the S.M.A.R.T. data set and whether the SSD has an anomaly, and taking a number of S.M.A.R.T. data with high correlation as the test data for determining whether the SSD has the anomaly.

For the NAND flash cell threshold voltage distribution data, the performing feature extraction may include normalizing the NAND flash cell threshold voltage distribution data, based on the normalized NAND flash cell threshold voltage distribution data, determining at least one correlation value of a number of NAND flash cells in each voltage interval to obtain at least one row vector, and splicing the at least one row vector into one row vector.

The at least one correlation value may be at least one of a maximum, a median, and an average.

For the bit error rate eye diagram data, the performing features extraction may include dividing an eye region of the bit error rate eye diagram data into multiple segments in a vertical direction, and determining an average height of each segment to obtain a first row vector, dividing the eye region of the bit error rate eye diagram data into multiple segments in a horizontal direction, and determining an average width of each segment to obtain a second row vector, and splicing the first row vector and the second row vector into one row vector.

According to an example embodiment of the present disclosure, an anomaly detection processing device for solid-state drive SSD may include a memory configured to store computer-executable instructions, and a processor configured to execute the computer-executable instructions stored in the memory such that the processor is configured to collect test data of SSD, the test data including at least one of self-monitoring, analysis and reporting technology S.M.A.R.T. data, NAND flash cell threshold voltage distribution data, and bit error rate eye diagram data, determine whether the SSD has an anomaly based on the test data, and determine an anomaly cause of the SSD based on a subset of the test data, the subset including specific test data based on which the SSD has been determined to have the anomaly.

The processor may be further configured to determine whether the SSD has the anomaly, based on the S.M.A.R.T. data by using a trained first anomaly detection model, based on the NAND flash cell threshold voltage distribution data by using a second anomaly detection model, and based on the bit error rate eye diagram data by using a trained third anomaly detection model, or determining whether the SSD has the anomaly based on the S.M.A.R.T. data, the NAND flash cell threshold voltage distribution data, and the bit error rate eye diagram data, by using a trained anomaly detection model.

The processor may be further configured to determine, by using a trained anomaly cause analysis model, the anomaly cause of the SSD based on the subset of the test data.

The processor may be further configured to perform feature extraction on the test data to obtain features of test data, before determining whether the SSD has the anomaly.

For S.M.A.R.T. data, the processor may be further configured to collect a S.M.A.R.T. data set of the SSD, the S.M.A.R.T. data set including S.M.A.R.T. data, determining a correlation between each S.M.A.R.T. data in the S.M.A.R.T. dataset and whether the SSD has the anomaly, take a number of S.M.A.R.T. data with high correlation as the test data for determining whether the SSD has the anomaly.

For the NAND flash cell threshold voltage distribution data, the processor may be further configured to normalize the NAND flash cell threshold voltage distribution data, based on normalized NAND flash cell threshold voltage distribution data, determine at least one correlation value of a number of NAND flash cells in each voltage interval to obtain at least one row vector, and splicing the at least one row vector into one row vector.

The at least one correlation value may be at least one of a maximum, a median, and an average.

For the bit error rate eye diagram data, the processor may be further configured to divide an eye region of the bit error rate eye diagram data into multiple segments in a vertical direction, and determining an average height of each segment to obtain a first row vector, divide the eye region of the bit error rate eye diagram data into multiple segments in a horizontal direction, and determining an average width of each segment to a the second row vector, and splicing the first row vector and the second row vector into one row vector.

According to an example embodiment of the present disclosure, there is provided an electronic apparatus, comprising a memory on which computer-executable instructions are stored and a processor which executes the above method when the instructions are executed by the processor.

According to an example embodiment of the present disclosure, there is provided a non-transitory computer-readable medium, on which computer-executable instructions are stored, which when executed by at least one processor, cause an electronic apparatus to perform the above method.

According to some example embodiments of the present disclosure, by conducting test data collection, anomaly detection and anomaly cause analysis, the problem of insufficient automation, reliance on manual operation, and insufficient intelligence can be greatly improved. According to some example embodiments of the present disclosure, possible anomalies may be more comprehensively covered by conducting anomaly detection on the SSD by collecting and processing multiple types of data (e.g., S.M.A.R.T. data, NAND flash cell threshold voltage distribution data, and bit error rate eye diagram data).

According to some example embodiments of the present disclosure, the lack of explanation as to the anomaly cause can be solved by locating the anomaly cause. Furthermore, according to some example embodiments of the present disclosure, through the feature extraction method for the NAND flash cell threshold voltage distribution data and the bit error rate eye diagram data, the physical meaning can be retained while reducing the dimension of the data and the resource consumption. Therefore, the present inventive concepts can effectively improve the efficiency, comprehensiveness, accuracy and interpretation of anomaly detection for the SSD.

### BRIEF DESCRIPTION OF THE DRAWINGS

The above and other objectives and features of example embodiments of the present disclosure will become clearer through the following description in conjunction with the accompanying drawings that show some example embodiments, in which:

FIG. 1 is a flowchart illustrating an anomaly detection processing method for SSD according to an example embodiment of the present disclosure;

FIG. 2 is a schematic diagram illustrating the feature extraction of NAND flash cell threshold voltage distribution data according to an example embodiment of the present disclosure;

FIG. 3 is a schematic diagram illustrating the feature extraction of bit error rate eye diagram data according to an example embodiment of the present disclosure;

FIG. 4 is a schematic diagram illustrating an offline task processing and online detection processing of the anomaly detection processing method for SSD according to an example embodiment of the present disclosure;

FIG. 5 is a block diagram illustrating an anomaly detection processing device for SSD according to an example embodiment of the present disclosure.

### DETAILED DESCRIPTION

In the following, with reference to the drawings, various example embodiments of the present disclosure are described, wherein the same reference number is used to indicate identical or similar elements, features, and structures. However, the present disclosure is not intended to be limited to specific example described herein, and is intended to cover all modifications, equivalents and/or substitutes of the present disclosure, as long as they are within the scope of the appended claims and equivalents. Terms and phrases used in the following descriptions and claims are not limited to their dictionary meanings, but are only used to enable a clear and consistent understanding of the present disclosure. Thus, it should be obvious to those skilled in the art that the following descriptions of various example embodiments of the present disclosure are provided for illustrative purposes only, rather than the purpose of restricting the present disclosure limited by the appended claims and their equivalents.

It should be understood that the singular form includes the plural form, unless the context expressly states otherwise. As used herein, the terms “include”, “contain”, and “have” indicate the existence of a disclosed feature, operation, or element, but do not exclude other functions, operations, or elements.

For example, the expression “A or B,” “at least one of A and/or B,” “at least one of A or B,” or “at least one of A and B” may indicate (1) A, (2) B, or (3) both A and B.

In various example embodiments of the present disclosure, when a component (e.g., a first component) is referred to as “coupled” or “connected” with another component (e.g., a second component) or is “coupled” or “connected” to another component (e.g., a second component), the component may be directly connected to the other component, or may be connected to the other component by another component (e.g., a third component). In contrast, when a component (e.g., a first component) is referred to as “directly coupled” or “directly connected” with another component (e.g., a second component) or is directly coupled to or directly connected to another component (e.g., a second component), there is no other component (e.g., a third component) between the component and the other component.

The expression “configured to” used in describing various embodiments of the present disclosure may, for example, be used interchangeably with the expression such as “applicable to”, “have the ability of”, “designed as”, “fit in”, “manufactured to” and “be able to”. The term “configured to” does not necessarily mean that “specifically designed” according to the hardware. Conversely, in some cases, the expression “a device configured to . . . ” may indicate the device and another device or part of the device “capable of . . . ”. For example, the expression “a processor configured to perform A, B and C” may indicate a dedicated processor (e.g., embedded processor) configured to perform the corresponding operation or the general-purpose processor (e.g., a central processing unit CPU or an application processor (AP)) configured to perform the corresponding operation by executing at least one software program stored in the storage device.

The terms used herein is intended to describe certain example embodiments of the present disclosure, and is not intended to limit scopes of example embodiments. Unless otherwise indicated herein, all terms used herein (including technical or scientific terms) may have the same meaning as those commonly understood by those skilled in the art. In general, terms defined in dictionaries should be deemed to have the same meaning as the context in the relevant field, and should not be understood differently or understood as having an overly formal meaning unless explicitly defined herein. In any case, the terms defined in the present disclosure are not intended to be construed to exclude example embodiments of the present disclosure.

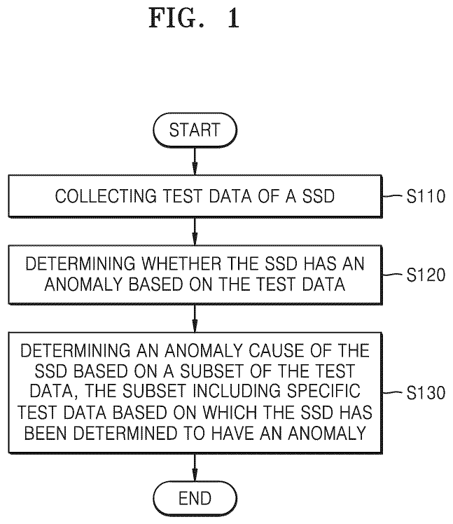

FIG. 1 is a flowchart illustrating an anomaly detection processing method for SSD according to an example embodiment of the present disclosure.

Referring to FIG. 1, in step S110, test data of an SSD may be collected. Wherein, the test data may include at least one of self-monitoring, analysis and reporting technology (S.M.A.R.T.) data, NAND flash cell threshold voltage distribution data, and bit error rate eye diagram data. Only as an example rather than the limitation, the above S.M.A.R.T. data may be traditional S.M.A.R.T. data or Extended S.M.A.R.T. data, and those skilled in the art can choose one according to actual needs.

For example, various types of data generated by the SSD during testing procedure may be collected, wherein the testing procedure may be a test performed in a semiconductor factory, a test performed by a user, or other tests. Only as an example rather than the limitation, test data may also be collected in real time.

In addition, the collected test data may be parsed according to actual needs, so as to perform key information extraction and structured processing of unstructured data and store test data in a database (e.g., time series database or relational database) for subsequent operations.

Before the test data is parsed, the test data may be transmitted to the execution device that will parse the test data (e.g., to a data center) according to actual needs.

In operation S120, whether the SSD has an anomaly is determined based on the test data.

For example, the determining whether the SSD has an anomaly may include determining whether the SSD has an anomaly by using the S.M.A.R.T. data through a trained first anomaly detection model, by using the NAND flash cell threshold voltage distribution data through a second anomaly detection model, or by using the bit error rate eye diagram data through a trained third anomaly detection model. In other words, whether the SSD has an anomaly may be determined by using the S.M.A.R.T. data, the NAND flash cell threshold voltage distribution data, or the bit error rate eye diagram data through a trained anomaly detection model. Only as an example rather than the limitation, the first anomaly detection model may be trained based on previously collected S.M.A.R.T. data, the second anomaly detection model may be trained based on previously collected NAND flash cell threshold voltage distribution data, the third anomaly detection model may be trained based on previously collected bit error rate eye diagram data. Each anomaly detection model may be trained based on a corresponding one of the previously collected S.M.A.R.T. data, NAND flash cell threshold voltage distribution data, and bit error rate eye diagram data.

Only as an example rather than the limitation, the training of the anomaly detection model (e.g., the first anomaly detection model, the second anomaly detection model, and the third anomaly detection model and the anomaly detection model described above) may be performed at regular intervals (e.g., 30 days), and the training may be performed based on test data within the most recent desired (or alternatively, predetermined) period (e.g., three months), that is, the input of the anomaly detection model is the test data and the output is whether the SSD has an anomaly. Here, the above offline training process may follow the training operations of traditional machine learning models, and the machine learning algorithms that may be used include but not limited to isolated forests, random forests, decision trees, support vector machines, neural networks, etc. The offline trained anomaly detection model may be used to perform anomaly detection on the collected test data.

Further, before whether the SSD has an anomaly is determined in operation S120, feature extraction may be performed on the test data to obtain features of the test data, and corresponding processing may be subsequently performed on the features of the test data. For example, whether the SSD has an anomaly is determined based on the features of the test data in operation S120. Feature extraction for S.M.A.R.T. data, NAND flash cell threshold voltage distribution data, and bit error rate eye diagram data will be described in detail below.

### S.M.A.R.T. Data

For the S.M.A.R.T. data, the collecting of the test data for SSD may include the following operations:

(1) collecting a S.M.A.R.T. data set of the SSD, wherein the S.M.A.R.T. data set comprises S.M.A.R.T. data.

(2) determining the correlation between each S.M.A.R.T. data in the S.M.A.R.T. data set and whether the SSD has an anomaly. Here, only as an example rather than the limitation, the correlation may be a Spearman correlation coefficient, a Pearson correlation coefficient, etc.

(3) taking a desired (or alternatively, predetermined) number of S.M.A.R.T. data with high correlation as the test data for determining whether the SSD has an anomaly. For example, the S.M.A.R.T. data may be sorted by the correlation, and a desired (or alternatively, predetermined) number of S.M.A.R.T. data with high correlation or a desired (or alternatively, predetermined) percentage (e.g., 50%) of S.M.A.R.T. data with relative high correlation may be selected as test data for determining whether the SSD has an anomaly. In addition, a desired (or alternatively, predetermined) number of S.M.A.R.T. data determined for each vendor may be saved to an attribute feature table.

In addition, only as an example rather than the limitation, because S.M.A.R.T. data are customized by vendors, S.M.A.R.T. data of different vendors may be greatly different from each other. Therefore, the performing of feature extraction on the test data to obtain the features of the test data may determine the S.M.A.R.T. data in the S.M.A.R.T. data set with regard to the corresponding vendor. In addition, if the attribute feature table is saved, the S.M.A.R.T. data may be determined based on the attribute feature table.

The above operation of collecting of the test data for SSD may be performed periodically, because the S.M.A.R.T. data customized by each vendor in the actual test environment may change over time. Thus, the above operation of determining a desired (or alternatively, predetermined) number of S.M.A.R.T. data for each vendor may be periodically performed to dynamically update and maintain the data/attribute feature table of the S.M.A.R.T. data set to ensure the accuracy of data feature extraction.

### NAND Flash Cell Threshold Voltage Distribution Data

NAND flash errors are mainly caused by reading/writing interference and wear during the programming/erasing process, and the probability of errors increases as the number of reading, writing, and erasing increase and the time increases. The most effective monitoring data for NAND flash errors is the NAND flash cell threshold voltage distribution. The phenomenon of NAND flash errors is mainly the change in the NAND flash cell threshold voltage distribution, such as the offset or widening of the distribution.

Because the NAND flash cell threshold voltage distribution data is two-dimensional, and the length of each dimension is generally greater than 100, the usage of raw data may result in high resource consumption. The NAND flash cell threshold voltage distribution data itself contains corresponding physical significance, and its physical significance needs to be reserved in the feature extraction process, thus the general feature extraction method is not suitable. Therefore, it is proposed a feature extraction method for the NAND flash cell threshold voltage distribution data that can reduce the data dimension while reserving the physical significance.

For the NAND flash cell threshold voltage distribution data, the obtaining of the features of the test data may include the following operations:

(1) normalizing the NAND flash cell threshold voltage distribution data.

(2) based on the normalized NAND flash cell threshold voltage distribution data, determining at least one correlation value of the number of NAND flash cells in each voltage interval to obtain at least one row vector. Here, only as an example rather than the limitation, the at least one correlation value is at least one of a maximum, a median, and an average.

In one example embodiment, in a case of determining the maximum, the median, and the average of the number of NAND flash cells in each voltage interval, three row vectors of the maximum, the median, and the average may be obtained, respectively.

(3) splicing the at least one row vector into one row vector, and taking the one row vector as the features of the NAND flash cell threshold voltage distribution data.

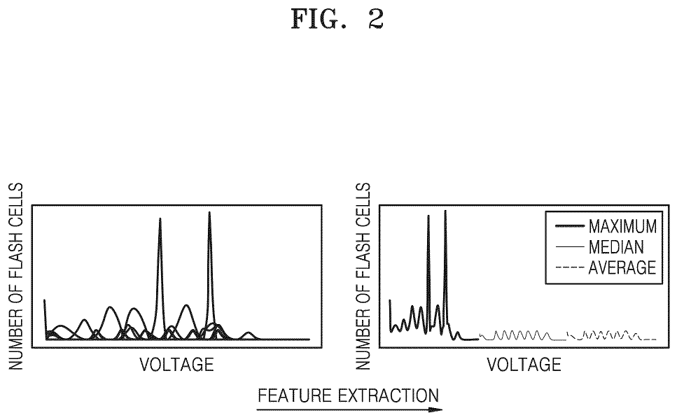

FIG. 2 is a schematic diagram illustrating the feature extraction of the NAND flash cell threshold voltage distribution data according to an example embodiment of the present disclosure. Referring to FIG. 2, through the above-mentioned operations, original multi-dimensional data can be dimensionally reduced to one-dimensional data (e.g., data in one row vector) while retaining the physical significance.

### Bit Error Rate Eye Diagram Data

Eye diagram is data used to quickly and visually assess a quality of a digital signal. The eye diagram obtained by a signal analysis tool reflects the influence of the physical device and the channel on the digital signal. Through the eye diagram, those skilled in the art can quickly obtain the signal measurement parameters of the tested product. Each data point in the eye diagram represents the bit error rate (BER), and each eye diagram can reflect signal integrity within one time window.

The tolerance for BER may be different in different types of SSD or different scenarios. Thus, the BER may be sampled based on a desired (or alternatively, predetermined) threshold and a BER having a value less than a set threshold (e.g., “0”), is considered to have no influence on signal transmission.

Similar to the NAND flash cell threshold voltage distribution data, the bit error rate eye diagram data is also two-dimensional and contains corresponding physical significance. The bit error rate has the same problem as the NAND flash cell threshold voltage distribution data during feature extraction. Therefore, it is proposed a feature extraction method for the bit error rate eye diagram data that can reduce the data dimension while reserving the physical significance. For the bit error rate eye diagram data, because signal integrity is mainly related to the size of the eye area in the eye diagram, it is considered to perform segment statistics on the width and height of the eye diagram to reduce the dimension of the data.

For the bit error rate eye diagram data, the obtaining of the features of the test data may include the following operations:

(1) dividing an eye region of the bit error rate eye diagram data into multiple segments in the vertical direction, and determining the average height of each segment to obtain the first row vector.

(2) dividing the eye region of the bit error rate eye diagram data into multiple segments in the horizontal direction, and determining the average width of each segment to obtain the second row vector.

(3) splicing the first row vector and the second row vector into one row vector, and use the one row vector as the features of the bit error rate eye diagram data.

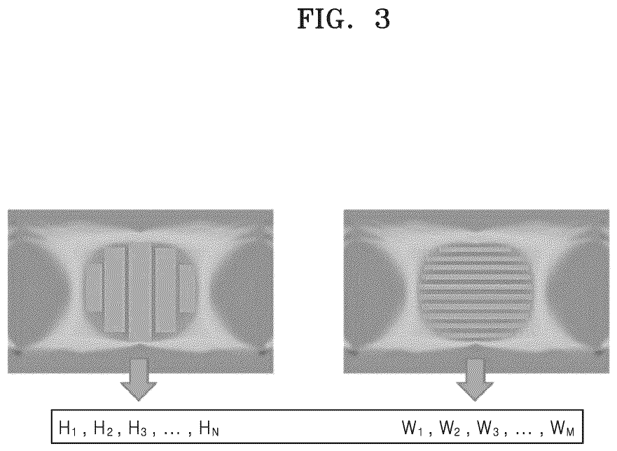

FIG. 3 is a schematic diagram illustrating the feature extraction of bit error rate eye diagram data according to an example embodiment of the present disclosure. Referring to FIG. 3, by the above operations, the average height of vertically divided segments H1, H2, H3, . . . , HN (N is a positive integer) and the average width of horizontally divided segments W1, W2, W3, . . . , WM (M is a positive integer) can be spliced together, original multi-dimensional data can be dimensionally reduced to one-dimensional data while reserving the physical significance.

Returning to FIG. 1, in operation S130, an anomaly cause of the SSD is determined based on a subset of the test data, the subset including specific test data based on which the SSD has been determined to have an anomaly.

For example, the determining of the anomaly cause of the SSD may include determining the anomaly cause of the SSD based on the specific test data, based on which the SSD has been determined to have an anomaly, through (or by using) a trained anomaly cause analysis model. Only as an example rather than the limitation, the anomaly cause analysis model may be trained based on previously collected test data (e.g., a subset of the previously collected test data) based on which the SSD was determined to have an anomaly.

Only as an example rather than the limitation, the training of the anomaly cause analysis model also may be performed at regular intervals (e.g., 30 days), and the training may be performed based on test data within the most recent desired (or alternatively, predetermined) period (e.g., three months). That is, the input of the anomaly cause analysis model is the specific test data based on which the SSD has been determined to have an anomaly and the output is the specific anomaly cause (e.g., an anomaly in NAND/tantalum capacitor/firmware/system signal). Here, the above offline training flow may follow the training operations of traditional machine learning models, and the machine learning algorithms that may be used include, but not limited to, isolated forests, random forests, decision trees, support vector machines, neural networks, etc. The offline trained anomaly cause analysis model may be used to locate the anomaly cause for the collected test data. It should be noted that the corresponding anomaly cause analysis model may be correspondingly trained for different types of test data (e.g., S.M.A.R.T. data, NAND flash cell threshold voltage distribution data, and bit error rate eye diagram data).

In addition, the anomaly detection model and the anomaly cause analysis model may be trained at the same time point to ensure consistency between the models.

After operation S130, only as an example rather than the limitation, the SSD may be further correspondingly processed based on the anomaly cause of the SSD. Here, the SSD may be processed automatically.

For example, all the anomaly causes that occur in the SSD may be classified into different levels in advance, and the processing flows corresponding to the classified levels may be determined, respectively. Here, the determined levels and the corresponding processing flows may be saved to an anomaly level table.

Subsequently, the current anomaly cause level may be determined based on the SSD anomaly cause, and the processing flow (e.g., launching a specific monitoring script, executing additional test cases, or terminating the test) corresponding to the current anomaly cause level may be performed. In addition, if the anomaly level table is saved, the processing flow corresponding to the level may be looked up in the anomaly level table.

It should be understood that operations S120˜S130 may be executed for once based on operation S110 collecting test data for a desired (or alternatively, predetermined) period (e.g., 5 minutes). If it is determined that there is an anomaly in operation S120, then the method may proceed to operation S130. Otherwise, the method may return to operation S110 to collect data for the next period.

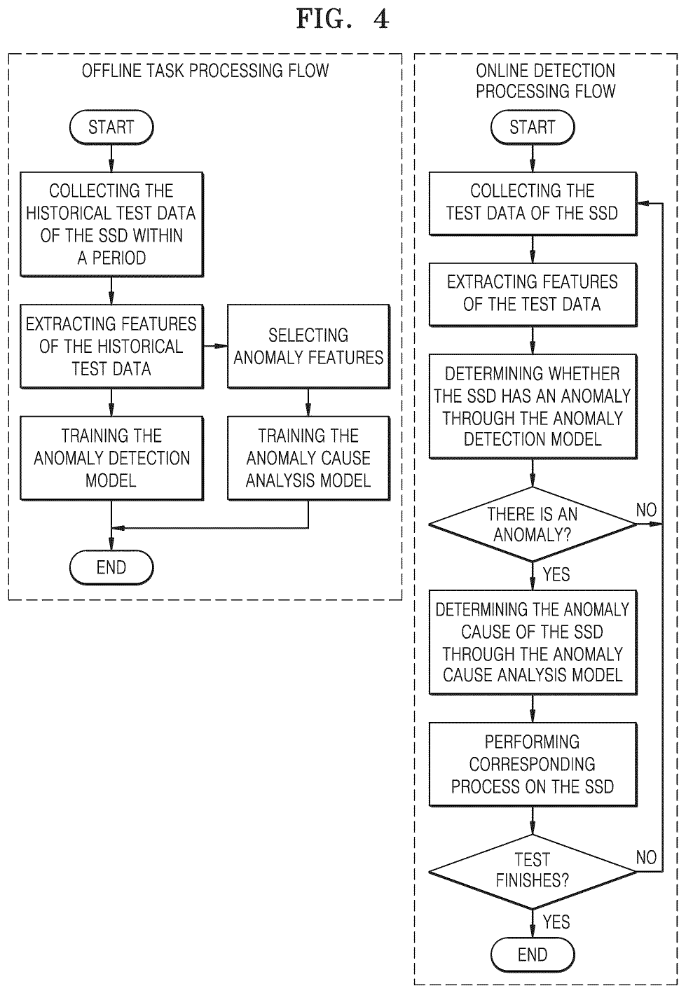

From the above description, it can be seen that the overall flow of the anomaly detection processing method for SSD according to an example embodiment of the present disclosure may be divided into two parts, that is, offline task processing flow and online detection processing flow. Below, the anomaly detection processing method for SSD according to an example embodiment of the present inventive concepts will be described with reference to FIG. 4 from the perspective of offline task processing flow and online detection processing flow.

FIG. 4 is a schematic diagram illustrating an offline task processing and online detection processing of an anomaly detection processing method for SSD according to an example embodiment of the present disclosure.

Referring to FIG. 4, the offline task processing flow may train the anomaly detection model and the anomaly cause analysis model with all the test data and anomaly test data (e.g., training data sets) which are previously collected within a desired (or alternatively, predetermined) period. The specific flow of the offline task processing may include collecting the historical test data (e.g., S.M.A.R.T. data, NAND flash cell threshold voltage distribution data, and/or bit error rate eye chart data) of the SSD within the desired (or alternatively, predetermined) period, extracting features of the historical test data as data sets, training the anomaly detection model and the anomaly cause analysis model using all features and selected anomaly features, respectively.

On the other hand, the online detection processing flow may perform anomaly detection and cause analysis processing for the currently collected test data, the specific flow of the online detection processing may include collecting the test data (e.g., S.M.A.R.T. data, NAND flash cell threshold voltage distribution data, and/or bit error rate eye diagram data) of the tested SSD, extracting features of the test data, determining, using the anomaly detection model, whether the SSD has an anomaly based on the features of the test data, returning to continue the collecting of the test data for the next period if it is determined that the SSD has no anomaly, determining, using the anomaly cause analysis model, the anomaly cause of the SSD based on the features of the test data based if it is determined that the SSD has an anomaly, processing the SSD based on the anomaly cause of the SSD, then returning to continue the collecting of the test data for the next period if the test does not finish, and ending the entire process ends if the test end.

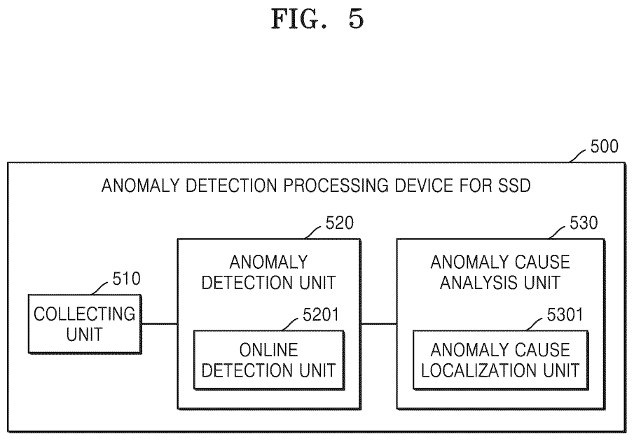

FIG. 5 is a block diagram illustrating an anomaly detection processing device for SSD according to an example embodiment of the present disclosure.

Referring to FIG. 5, the anomaly detection processing device 500 for the SSD may include a collecting unit 510, an anomaly detection unit 520, and an anomaly cause analysis unit 530. A collecting unit 510, an anomaly detection unit 520, and an anomaly cause analysis unit 530 may refer to functional units of a processor.

The collecting unit 510 may be configured to collect test data of SSD. Only as an example rather than the limitation, the test data may include at least one of S.M.A.R.T. data, NAND flash cell threshold voltage distribution data, and bit error rate eye diagram data.

The anomaly detection unit 520 may be configured to determine whether the SSD has an anomaly based on the test data.

For example, the anomaly detection unit 520 may include an online detection unit 5201, which may be configured to perform (1) determining whether the SSD has an anomaly, based on the S.M.A.R.T. data through (or by using) a trained first anomaly detection model, based on the NAND flash cell threshold voltage distribution data through (or by using) a second anomaly detection model, and based on the bit error rate eye diagram data through (or by using) a trained third anomaly detection model, or (2) determining whether the SSD has an anomaly, based on the S.M.A.R.T. data, the NAND flash cell threshold voltage distribution data, and the bit error rate eye diagram data through (or by using) a trained anomaly detection model. In addition, only as an example rather than the limitation, the anomaly detection unit 520 may further include an offline training unit configured to train the anomaly detection model based on previously collected test data.

The anomaly detection processing device 500 for the SSD according to an example embodiment of the present inventive concepts may further include a feature extraction unit (not shown). The feature extraction unit may be configured to perform feature extraction on the test data to obtain features of test data before whether the SSD has an anomaly is determined.

Here, for S.M.A.R.T. data, the feature extraction unit may be further configured to perform (1) collecting a S.M.A.R.T. data set of the SSD, wherein the S.M.A.R.T. data set includes S.M.A.R.T. data, (2) determining the correlation between each S.M.A.R.T. data in the S.M.A.R.T. data set and determining that the SSD has an anomaly, and/or (3) taking a desired (or alternatively, predetermined) number of S.M.A.R.T. data with high correlation as the test data for determining whether the SSD has an anomaly.

In addition, for NAND flash cell threshold voltage distribution data, the feature extraction unit may be further configured to perform (1) normalizing the NAND flash cell threshold voltage distribution data, (2) based on normalized NAND flash cell threshold voltage distribution data, determining at least one correlation value of the number of NAND flash cells in each voltage interval to obtain at least one row vector, (3) splicing the at least one row vector into one row vector. Only as an example rather than the limitation, the at least one relevant value is at least one of a maximum, a median, and an average.

In addition, for bit error rate eye diagram data, the feature extraction unit may be further configured to perform (1) dividing an eye region of the bit error rate eye diagram data into multiple segments in the vertical direction, (2) determining the average height of each segment to obtain the first row vector, (3) dividing the eye region of the bit error rate eye diagram data into multiple segments in the horizontal direction, (4) determining the average width of each segment to obtain the second row vector, (5) splicing the first row vector and the second row vector into one row vector.

The anomaly cause analysis unit 530 may be configured to determine an anomaly cause of the SSD based on a subset of the test data, the subset including specific test data based on which the SSD is determined to have an anomaly.

For example, the anomaly cause analysis unit 530 may include an anomaly cause localization unit 5301. The anomaly cause localization unit 5301 may be configured to determine, using a trained anomaly cause analysis model, the anomaly cause of the SSD based on specific test data based on which the SSD has been determined to have an anomaly. Further, only as an example rather than the limitation, the anomaly cause analysis unit 530 may include an offline training unit (not shown). The offline training unit may be configured to train the anomaly cause analysis model based on previously collected test data (e.g., a subset of the previously collected test data) based on which the SSD has been determined to have an anomaly.

Only as an example rather than the limitation, the anomaly detection model and the anomaly cause analysis model may be trained at the same time point.

The anomaly detection processing device 500 for the SSD according to an example embodiment of the present inventive concepts may further include an anomaly processing unit (not shown) configured to process the SSD based on the anomaly cause of the SSD. For example, the processing of the anomaly cause detection processing device 500 on the anomaly cause of the SSD may include operations such as data re-location, wear-leveling, repairing with redundant cells, and/or re-programming.

For example, the anomaly processing unit may further be configured to perform (1) classifying all the anomaly cause that the SSD may occur into different levels in advance, and (2) determining the processing flows corresponding to the classified levels, respectively. In addition, the anomaly processing unit may further be configured to perform determining the current anomaly cause level and performing the processing flow corresponding to the level.

According to the example embodiments of the present disclosure, an electronic apparatus is provided. The electronic apparatus may include a memory configured to store computer-executable instructions thereon and a processor configured to execute the computer-executable instructions to perform the above anomaly detection processing method for SSD when the instructions are executed by the processor.

According to the example embodiments of the present disclosure, a computer readable medium, on which computer-executable instructions are stored, which executes the above anomaly detection processing method for SSD when the instructions are executed. Here, the example of the computer readable medium includes: Read Only Memory (ROM), Random Access Programmable Read Only Memory (PROM), Electrically Erasable Programmable Read Only Memory (EEPROM), Random Access Memory (RAM), Dynamic Random Access Memory (DRAM), Static Random Access Memory (SRAM), Flash Memory, Non-Volatile Memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disk storage, hard disk drive (HDD), solid-state drive (SSD), card memory (such as multimedia card, Secure Digital (SD) card or Extreme Digital (XD) card), magnetic tape, floppy disk, magneto-optical data storage device, optical data storage device, hard disk, SSD, and any other device that is configured to store the computer program and any associated data, data files and data structures in a non-temporary manner, and to provide the computer program and any associated data, data files and data structures to the processor or computer so that the processor or computer can execute the computer program. The computer program in the above computer-readable medium may be run in an environment deployed in a computer device such as a client, host, an agent device, or a server. Furthermore, in one example, the computer program and any associated data, data files and data structures are distributed on a networked computer system, such that the computer program and any associated data, data files and data structures are stored, accessed and executed in a distributed manner by one or more processors or computers.

According to some example embodiments of the present disclosure, (1) by conducting test data collection, anomaly detection and anomaly cause analysis, the problem of insufficient automation, reliance on manual operation and insufficient intelligence can be greatly improved, (2) by conducting anomaly detection on the SSD by collecting and processing multiple types of data (e.g., S.M.A.R.T. data, NAND flash cell threshold voltage distribution data, and/or bit error rate eye diagram data) possible anomalies may be more comprehensively covered compared to a single data indicator based on one type of data, and (3) by locating the anomaly cause, the lack of explanation as to the anomaly cause may be solved. In addition, through the feature extraction method for the NAND flash cell threshold voltage distribution data and the bit error rate eye diagram data, the physical meaning may be retained while reducing the dimension of the data, and the resource consumption may be reduced. Therefore, the present inventive concepts may effectively improve the efficiency, comprehensiveness, accuracy and interpretation of anomaly detection for the SSD.

Any functional blocks shown in the figures and described above may be implemented in processing circuitry such as hardware including logic circuits, a hardware/software combination such as a processor executing software, or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

While the present inventive concepts have been shown and described with reference to certain example embodiments, it should be understood by those skilled in the art that various changes in form and details may be made therein without departing from the spirit and range of the present inventive concepts which are defined by the appended claims and the equivalents.

What is claimed is:

1. An anomaly detection processing method for solid-state drive (SSD), comprising:
collecting test data of an SSD, the test data including at least one of self-monitoring, analysis and reporting technology (S.M.A.R.T.) data, NAND flash cell threshold voltage distribution data, and bit error rate eye diagram data;
determining whether the SSD has an anomaly based on the test data; and
determining an anomaly cause of the SSD based on a subset of the test data, the subset including specific test data based on which the SSD has been determined to have the anomaly.

2. The anomaly detection processing method for the SSD according to claim 1, wherein the determining whether the SSD has an anomaly comprises:
determining whether the SSD has the anomaly, based on the S.M.A.R.T. data by using a trained first anomaly detection model, based on the NAND flash cell threshold voltage distribution data by using a second anomaly detection model, and based on the bit error rate eye diagram data by using a trained third anomaly detection model; or
determining whether the SSD has the anomaly based on the S.M.A.R.T. data, the NAND flash cell threshold voltage distribution data, and the bit error rate eye diagram data, by using a trained anomaly detection model.

3. The anomaly detection processing method for the SSD according to claim 2, wherein the determining an anomaly cause of the SSD comprises:
determining, by using a trained anomaly cause analysis model, the anomaly cause of the SSD based on the subset of the test data.

4. The anomaly detection processing method for the SSD according to claim 2, further comprising:
before the determining whether the SSD has an anomaly, performing feature extraction on the test data to obtain features of the test data.

5. The anomaly detection processing method for the SSD according to claim 1, wherein for the S.M.A.R.T. data, the collecting test data of an SSD comprises:
collecting a S.M.A.R.T. data set of the SSD, the S.M.A.R.T. data set including S.M.A.R.T. data;
determining a correlation between each S.M.A.R.T. data in the S.M.A.R.T. data set and whether the SSD has the anomaly; and
taking a number of S.M.A.R.T. data with high correlation as the test data for determining whether the SSD has the anomaly.

6. The anomaly detection processing method for the SSD according to claim 4, wherein for the NAND flash cell threshold voltage distribution data, the performing feature extraction comprises:
normalizing the NAND flash cell threshold voltage distribution data;
based on the normalized NAND flash cell threshold voltage distribution data, determining at least one correlation value of a number of NAND flash cells in each voltage interval to obtain at least one row vector; and
splicing the at least one row vector into one row vector.

7. The anomaly detection processing method for the SSD according to claim 6, wherein the at least one correlation value is at least one of a maximum, a median, and an average.

8. The anomaly detection processing method for the SSD according to claim 4, wherein for the bit error rate eye diagram data, the performing feature extraction comprises:
dividing an eye region of the bit error rate eye diagram data into multiple segments in a vertical direction, and determining an average height of each segment to obtain a first row vector;
dividing the eye region of the bit error rate eye diagram data into multiple segments in a horizontal direction, and determining an average width of each segment to obtain a second row vector; and
splicing the first row vector and the second row vector into one row vector.

9. An anomaly detection processing device for solid-state drive SSD, comprising:
a memory configured to store computer-executable instructions; and
a processor configured to execute the computer-executable instructions stored in the memory such that the processor is configured to,
collect test data of SSD, the test data including at least one of self-monitoring, analysis and reporting technology S.M.A.R.T. data, NAND flash cell threshold voltage distribution data, and bit error rate eye diagram data,
determine whether the SSD has an anomaly based on the test data, and
determine an anomaly cause of the SSD based on a subset of the test data, the subset including specific test data based on which the SSD has been determined to have the anomaly.

10. The anomaly detection processing device of the SSD according to claim 9, wherein the processor is further configured to,
determine whether the SSD has the anomaly, based on the S.M.A.R.T. data by using a trained first anomaly detection model, based on the NAND flash cell threshold voltage distribution data by using a second anomaly detection model, and based on the bit error rate eye diagram data by using a trained third anomaly detection model; or
determining whether the SSD has the anomaly based on the S.M.A.R.T. data, the NAND flash cell threshold voltage distribution data, and the bit error rate eye diagram data, by using a trained anomaly detection model.

11. The SSD anomaly detection processing device according to claim 10, wherein the processor is further configured to,
determine, by using a trained anomaly cause analysis model, the anomaly cause of the SSD based on the subset of the test data.

12. The SSD anomaly detection processing device according to claim 10, wherein the processor is further configured to,
perform feature extraction on the test data to obtain features of test data before determining whether the SSD has the anomaly.

13. The anomaly detection processing device of the SSD according to claim 9, wherein for S.M.A.R.T. data, the processor is further configured to,
collect a S.M.A.R.T. data set of the SSD, the S.M.A.R.T. data set including S.M.A.R.T. data,
determine a correlation between each S.M.A.R.T. data in the S.M.A.R.T. data set and whether the SSD has the anomaly, and
take a number of S.M.A.R.T. data with high correlation as the test data for determining whether the SSD has the anomaly.

14. The anomaly detection processing device of the SSD according to claim 12, wherein for the NAND flash cell threshold voltage distribution data, the processor is further configured to,
normalize the NAND flash cell threshold voltage distribution data,
based on normalized NAND flash cell threshold voltage distribution data, determine at least one correlation value of a number of NAND flash cells in each voltage interval to obtain at least one row vector, and
splice the at least one row vector into one row vector.

15. The anomaly detection processing device of the SSD according to claim 14, wherein the at least one correlation value is at least one of a maximum, a median, and an average.

16. The anomaly detection processing device of the SSD according to claim 12, wherein for the bit error rate eye diagram data, the processor is further configured to,
divide an eye region of the bit error rate eye diagram data into multiple segments in a vertical direction, and determining an average height of each segment to obtain a first row vector,
divide the eye region of the bit error rate eye diagram data into multiple segments in a horizontal direction, and determining an average width of each segment to obtain a second row vector, and
splice the first row vector and the second row vector into one row vector.

17. A non-transitory computer-readable medium storing computer-executable instructions thereon, which when executed by at least one processor, cause an electronic apparatus to perform the method of claim 1.
